(19) United States
(12) Patent Application Publication
(10) Pub. No.: US 2005/0238160 A1
(43) Pub. Date: Oct. 27, 2005

(54) Enhanced Telephony Adapter Device and Methods

(75) Inventor: Martin T. Sunstrum, Calgary (CA)

Correspondence Address: Martin Sunstrum, 428, 3553-31 Street NW, Calgary, T2L 2K7, CA

(73) Assignee: AKSYS NETWORKS INC, Calgary (CA)

(21) Appl. No.: 10/905,138

(22) Filed: Dec. 17, 2004

Related U.S. Application Data
(60) Provisional application No. 60/481,812, filed on Dec. 18, 2003.

(51) Int. Cl. H04M 1/64; H04M 11/00; H04M 7/00

(52) U.S. Cl. 379/220.01; 379/88.01; 379/90.01

(57) ABSTRACT

A device and associated methods, that enhances analog telephony communications for an end-user by providing telephony capabilities that are typically too complex, cumbersome or costly for an individual end-user. The device provides a combination of traditional telephone capabilities with VOIP capabilities. Methods provide for the simplified use of the device from a conventional analog telephone.

### FIELD OF THE INVENTION

This invention relates generally to communications, more particularly, to customer premise-based analog and packet telecommunications.

### BACKGROUND OF THE INVENTION

The simple PSTN analog phone line is still the predominant method of providing voice communications to an end-user. Typically an end-user will connect a variety of end devices to this PSTN analog phone line such as analog phones, answering machines, caller-id devices, fax machines and computer modems.

For many end-users who desire or require more advanced and integrated telephony communication capabilities, these varieties of end devices are not able to provide these advanced capabilities. Many of these capabilities are found in business environments, but are too complex or costly for an individual user.

A simple example of an end device with limited advanced capabilities is the common analog phone answering machine. These are typically used in a residential or very small business environment. Various deficiencies are as follows:
End-user must interact with it manually by pressing buttons, rewinding, and listening to messages.
No easy facility to move the recorded voice messages in other storage devices, such as a PC.
Typically not convenient for a multi-user environment. A good example is a household with many family members. Access to the device must be in an area convenient for all users.
Access to voicemail messages when one is physically distant from the device is typically only via remote PSTN dial-in procedures.

There are applications that can allow your PC to act as an answering machine, and overcome many of these deficiencies. But this solution has the following disadvantages:
Requires a PC that is always on. When the PC acts as an answering machine and answers the call, this can be disruptive to the current user of the PC. If the PC operating system hangs, the PC voicemail application may fail to operate.
In situations where the PC has multiple user logins, the PC application must be installed and set to run for all potential logins. This is not very convenient.
Requires a specialized, less-common voice modem to be installed inside the computer.
PC Voicemail applications are not widespread and are not common across a variety of computer operating systems.
Computer operating system upgrades are relatively frequent and are sometimes are incompatible with the voicemail application software.
As is common in business environments, and becoming more common in residential environments, this method is not convenient when individual users have their own PC, instead of sharing a single PC.

Becoming more common in business environments are capabilities that allow computer telephony integration and call monitoring and recording capabilities. In addition, they have the ability to receive voicemails and/or phone call logs as e-mail. These capabilities are difficult to find in a simple end-user device. There are some PC applications that can handle some of these capabilities, but require the use of specialized hardware that needs to be installed in the PC.

In addition, the emergence of Voice-over-Internet Protocol (VoIP) communication capabilities is much sought after for businesses and individuals alike. But for individual end-users, this VoIP technology is cumbersome, and difficult to use with existing equipment.

Thus, a need exists for a simple, inventive single device and methods to provide all of these sought after advanced telephony capabilities that overcome these obstacles.

### SUMMARY OF THE INVENTION

With regard to the numerous limitations of the aforementioned prior art, the inventive telephony device leverages Ethernet LAN/WAN, TCP/IP and VoIP technologies to provide enhanced telephony capabilities. This inventive device provides superior telephony capabilities that are typically too complex or costly to the average individual end-user to deploy in a residential or business environment. It provide a way for users of a standard analog phone that has call-id capabilities to easily select amongst multiple VOIP services that they can use. It also provides for novel call handling for incoming FXO calls.

### BRIEF DESCRIPTION OF THE DRAWING FIGURES

FIG. 1 shows a block diagram of an illustrative Enhanced Telephony Adapter (ETA) system 100,

FIG. 2 shows a functional-level block diagram of an illustrative ETA Device 200 device;

FIG. 3 shows a block diagram of an illustrative Telephone System 300;

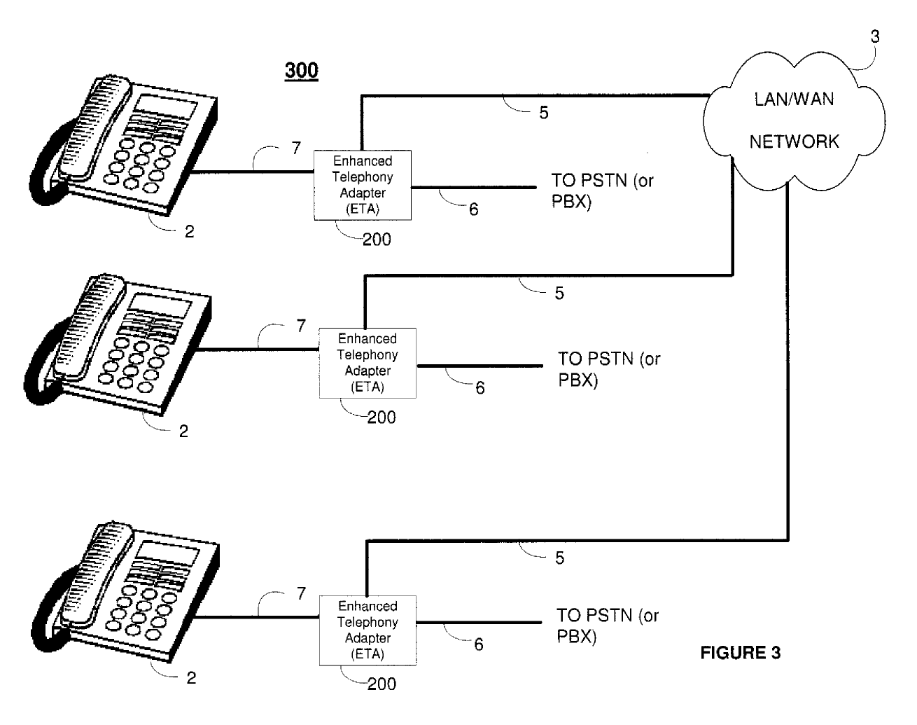

### DETAILED DESCRIPTION

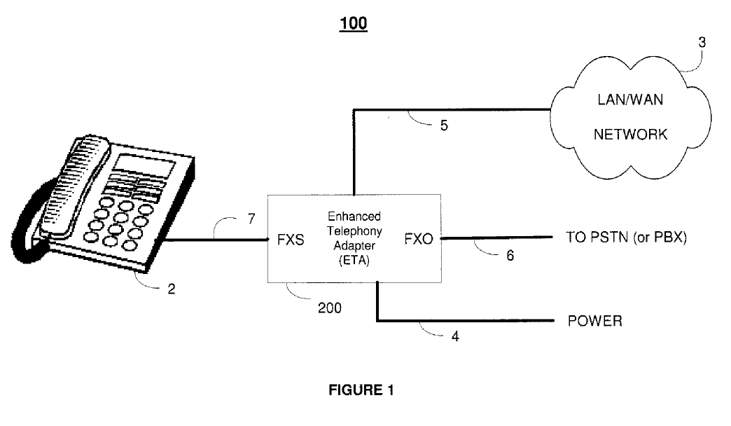

A preferred embodiment of the Enhanced Telephony Adapter (ETA) System 100 setup is illustrated in FIG. 1. Connected to the inventive device, ETA Device 200, on its FXS port, is of one (or more) Telephone Set 2. The Telephone Set 2 can be representative of a regular corded or cordless analog telephone, or other common telephone line devices such as a fax machine. Optionally connected to ETA Device 200, on its FXO port, is a connection to a regular phone line 6, representative of facilities provided by a load central office or PBX (not shown), and as is known in the art.

The ETA Device 200 is connected to a LAN/WAN Network 3 via LAN Connections 5. For the purposes of this description, each LAN Connection is assumed to be a commodity 10/100 Mbps IEEE 802.3 Ethernet LAN cable connection.

The LAN/WAN Network 3 operates using industry-standard TCP/IP networking protocols. This LAN/WAN Network 3 consists of load area network(s) (LAN) and/or wide area network(s) (WAN). This LAN/WAN Network 3 can be comprised of any one or more of the following items: load Ethernet switches, hubs, routers, firewalls, network address translators (NAT), intranets, pubic Internet, private TCP/IP WAN networks, or any other related network devices and implementations. The purpose of the LAN/WAN Network 3 is to provide a load and wide area switching network for transport of digitized voice and control data to/from the ETA Device 200, in addition to providing a communication medium for other common industry TCP/IP devices (PCs, printers, servers, Internet . . . ). These TCP/IP network elements, and the mechanisms behind their operation, are well known to one skilled in the art, and won't be described further.

Using just a regular analog phone in conjunction with the ETA Device 200 can provide the individual end-user with desirable advanced telephony features such as PC click-to-dial, call recording, call monitoring, auto-attendant, voicemail functionality, and VoIP calling capabilities.

One or more ETA Device 200 devices could be deployed in a residential or office environment for anyone who wants to still use a regular analog phone, but who needs simple, cost-effective access to enhanced telephony communication capabilities.

The methods behind the delivery of these features will be described later in this description.

ETA Description

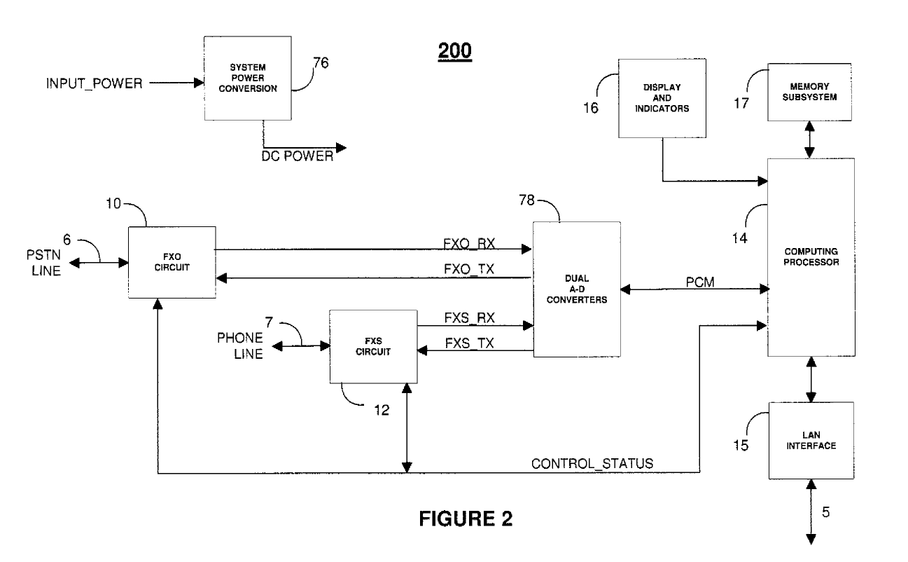

The ETA Device 200 device is the inventive apparatus for the ETA System 100 as shown in FIG. 1. An illustrative functional block diagram of a portion of ETA Device 200, which embodies the principles of the invention, is shown in FIG. 2. The following describes pertinent design details and the function of each element referenced in FIG. 2.

FXO Circuit 10;

FXO circuit 10 provides the functionality of a FXO circuit familiar to one skilled in the art. This includes ringing detectors, FSK demodulator, and on and off hook switch control. There is a 2 to 4 wire hybrid audio circuit interfacing the 2 wire PSTN line 6 loop start signal pair to the (4 wire) transmit and receive audio signals FXO_TX and FXO_RX respectively.

Appropriate status and control information is conveyed to/from Computing Processor 14 via the STATUS_CONTROL signal. Analog audio signals FXO_RX and FXO_TX are connected to the Dual A-D Converters 78.

FXS Circuit 12;

FXS Circuit 12 provides the functionality of a FXS circuit familiar to one skilled in the art. This includes ringing generator, FSK generator, DTMF detector, battery feed, and on and off hook detection. There is a 2 to 4 wire hybrid audio circuit interfacing the 2 wire phone line 7 loop start signal pair to the (4 wire) transmit and receive audio signals FXS_TX and FXS_RX respectively.

Appropriate status and control information is conveyed to/from Computing Processor 14 via the STATUS_CONTROL signal. Analog audio signals FXS_RX and FXS_TX are connected to the Dual A-D Converters 78.

Dual A-D Converters 78;

The Dual A-D Converters 78 provide 2 channels of analog-digital and digital-analog conversion paths to the analog audio signals FXS_TX, FXS_RX, FXO_TX and FXO_RX emanating from the FXS Circuit 12 and FXO Circuit 10. The digitized signals are transported to/from the Computing Processor 14 via a multiplexed digital data stream, such as a PCM stream bus, familiar to one skilled in the art.

System Power Conversion 76;

The System Power Conversion 76 provides various DC voltage rails as needed by the ETA Device 200. The appropriate DC rails are provided as needed by any specific electrical design. The INPUT POWER is any AC or DC input power signal that is appropriate for the design. It could be delivered via a wall power cube, or delivered through wires on the LAN cable (e.g. as defined by IEEE 802.3 of standard). Both of these methods are known by one skilled in the art.

Computing Processor 14;

Computing Processor 14 represents the digital control processor unit for execution of the main apparatus application firmware. It can consist of appropriate microprocessor and/or DSP processing devices as is required, and known by one skilled in the art. The Computing Processor 14 runs the application software resident in the Memory Subsystem 17.

A key element is that the Computing Processor 14 requires sufficient computing power and appropriate software algorithms to process audio signals. These capabilities include the following:
flexible audio frequency band tone and multi-tone generation and detection capabilities. This is used for such items as DTMF tone detection/generation, caller-id and call-waiting-id FSK signal detection, and various other common telephony tone signaling activities.
When digitized audio to/from the FXO and/or FXS circuits are transported across the LAN Interface 15, algorithms are required to perform appropriate line and/or acoustic echo cancellation within ETA Device 200. The design parameters around these echo cancellers are well known, and their performance criteria is well described in the G.168 standard.
ability to handle multiple independent instances of playing and recording audio data from/to the Memory Subsystem 17.
flexible audio gain control is required for all audio paths. This would include audio muting and automatic gain control circuits as needed.
flexible audio mixing, and if desired, audio conferencing control of various audio output and input paths. The audio mixing capabilities facilitate call recording and call monitoring capabilities. The mixing/conferencing with audio paths to/from the Dual A-D Converters 78 and one or more call sources to/from the LAN network.

Memory Subsystem 17;

Memory Subsystem 17 provides all of the volatile and non-volatile memory storage for the application software, data and algorithms, as required for any devices as part of the Computing Processor 14. Examples of this memory storage are combinations of flash memory, SDRAM memory, EEROM and similar devices are well known to one skilled in the art. The application software and algorithms contain all the functions to perform the necessary TCP/IP and VoIP protocol stacks such as TCP, UDP, RTP, SIP, SMTP, HTTP, FTP, and TFTP.

LAN Interface 15;

LAN Interface 15 provides the Ethernet 802.3 interface, which includes the media access controller (MAC) and physical interface (PHY). The LAN interface operatively connect the computing processor 14 to the LAN connection 5.

Inductors 16;

Inductors 16 is an optional element that represents common device items such as inductor LEDs, LCD displays and buttons. The interconnections of such are well known to one skilled in the art.

ETA System 100 Operation

General VoIP Protocol Operational Description

The LAN VoIP protocols defined herein follow conventional TCP/IP and Voice over Internet Protocol (VoIP) specific protocols. These protocols are defined by standard such as SIP, H.323 or MGCP, or the protocols could be proprietary extensions or variants of the aforementioned protocols. Alternatively, it could be a completely proprietary vendor protocol that perform similar functions. For messages transported using these protocols, reliability, priority and encryption mechanisms for message delivery are understood by those skilled in the art. For example, various schemes common to the practice of the art exist to ensure that voice data messages receive higher priority that other data messages. In addition, TCP/IP defines message delivery reliability schemes using TCP and UDP methods.

For the purposes of this patent description, we will describe the VoIP protocol functionalities of the ETA System 100 and ETA Device 200 with respect to the usage of the SIP and RTP protocols. For example, it is well understood by one skilled in the art that digitized audio data is transported across the LAN Interface via the RTP protocol, and call setup and control information is transported across the LAN Connection 5 via the SIP protocol. The IETF reference document that explains the SIP and RTP protocols can be found in RFC3261 and RFC3550 respectively.

The following is an illustrative example, with regard to general telephony and VoIP protocol operation of the ETA Device 200. When the incoming PSTN call arrives at the telephone line 6, it generates a ringing signal on the FXO port of ETA Device 200. Via the FXO circuit 10, the Computing Processor 14 is notified. The Computing Processor 14 can now ring up a user's analog phone 2 by activating the FXS Circuit 12. Alternatively the Computing Processor 14 can initiate a VoIP SIP call out to the LAN/WAN Network 3 by sending out the appropriate SIP INVITE messages. Alternatively, it could do both, ring both the user's analog phone 2, and initiate a VoIP SIP call. If the Computing Processor 14 receives a SIP OK message from the LAN/WAN Network 3, it can proceed to set up the call by setting the FXO Circuit 10 to an off-hook state, and to route the FXO_RX and FXO_TX audio signals through one channel of the Dual A-D Converters 86. This digitized audio is transported via the LAN Interface 15 via the RTP protocol to another VoIP endpoint on the LAN/WAN Network 3. Now a complete call path is in session between the FXO circuit 10, and a VoIP SIP session on the LAN/WAN Network 3.

For an incoming VoIP SIP call, a appropriate SIP INVITE message can be received at the ETA Device 200 via the LAN Interface 15. The Computing Processor 14 can ring up the user'ss analog telephone 2 via the FXS Circuit 12. The FXS Circuit 12 can detect when the user picks up the handset (or activates a speakerphone key press) of the analog telephone, and send this status information to the Computing Processor 14. The Computing Processor 14 can now send a SIP CK message to the initiating VoIP SIP call on the LAN/WAN Network 3. The Computing Processor 14 proceeds to set up the digitized audio paths between the VoIP RTP streams and FXS Circuit 12. Now a complete call path is in session between the user on the analog telephone and the VoIP SIP call on the LAN/WAN Network 3.

Alternatively, an incoming VoIP SIP call can be directed to the FXO port of the ETA Device 200. In this case, the Computing Processor 14 would instruct the FXO Circuit 10 to go off-hook. The VoIP SIP call would be presented with the dial tone originating from the PSTN. If the PSTN circuit were already in use by another analog phone on this PSTN line, then the user would join the existing call party, or the incoming VoIP call could be rejected depending upon the configuration of the device.

It is important to note that the call at the FXO Circuit 10, and the call at the FXS Circuit 11 are independent of each other. That is, the ETA Device 200 can simultaneously have an independent VoIP SIP call session on the FXO Circuit 10, and another independent SIP call session the FXS Circuit 11.

To one skilled in the art, it is apparent how a user initiates outgoing calls from their analog phone out to the PSTN via the FXO port, and to the LAN/WAN Network 3, via VoIP SIP methods. In addition, to one skilled in the art, they are familiar with how calls are terminated.

Another inventive method regarding advanced voice messaging capabilities of the ETA Device 200 is its optional ability to interface and manipulate directly with external LAN or WAN unified messaging storage services. Common to the art of unified messaging storage, an element of the art is a user having an option of handing their voicemail messages via their PC e-mail inbox, using the common POP3 or IMAP4 protocols. Conversely, the ETA Device 200 could also handle the voicemail message. This inventive method refers to the ETA Device 200 being able directly perform the POP3 or IMAP4 protocol interaction, with the appropriate administrative settings resident in the ETA Device 200.

An illustrative example of this method is where a user receives a voicemail message in their unified messaging storage server. They receive notification of this message in their e-mail inbox, and by the ETA Device 200 sending the appropriate FSK call-waiting message on the FXS port to the analog phone message-waiting lamp (or other methods such as stutter dial tone). If the user handles the message from the phone, the ETA Device 200 device will interact directly with the unified message storage server. If the user reviews the message, and deletes the message, the message will typically no longer appear in their e-mail inbox (assuming IMAP4 protocol is in use).

The ETA Device 200 also has an inventive method with respect to providing advanced auto-attendant and multi-user voicemail capabilities. The ETA Device 200 can answer incoming voice calls, from either the FXO port, or via a VoIP SIP call, and provide auto-attendant and voicemail services known to one skilled in the art.

For voicemail, the recorded messages can be stored locally on the ETA Device 200. But they can also be delivered out of the ETA Device 200 to the end user by the “store-forward” or “real-time” methods described above. The preferred method would be delivering it to the targeted recipient via e-mail, using SMTP protocol in the ETA Device 200. The advantage of this method is that it can deliver the voice message to any of the multiple users of the ETA Device 200, and can deliver it to them whether they are present locally or remotely anywhere in the world. In addition, this method removes the need for the ETA Device 200 to have large amount of memory storage for the voicemail message. The e-mail settings and audio greetings would be administratively entered in the ETA Device 200, as is familiar to one skilled in the art.

ETA Device 200 Inventive Operational Methods

An inventive method of the ETA Device 200 is what is called VoIP parallel extension. When in incoming PSTN call arrives on the FXO port 6 of the ETA Device 200, it will ring up the analog phone on the FXS port 7. An administrative setting can allow it to also initiate an outgoing VoIP call. The FXO call would be answered by which ever endpoint answers the call first, the VoIP or FXS endpoint. If both endpoints answer, and administrative setting would allow the two endpoints to conference together and have a simultaneous conversation with the caller on the FXO port. This inventive method allows the VoIP endpoint to simulate another phone extension, allowing the VoIP endpoint user to be located anywhere in the world.

An alternative embodiment of the ETA Device 200 is a device with only a FXO port, and no FXS port. The inventive method of the VoIP parallel extension still applies. With this device, analog phones in the premise would be connected to the same FXO port. When in incoming PSTN call arrives on the FXO port of the ETA Device 200, analog phones connected in parallel to the FXO port will ring as usual. In addition, the ETA Device 200 will also initiate an outgoing VoIP call. The FXO call would be answered by which endpoint answers the call first, the VoIP call endpoint or by an analog phone on the FXO port. If both endpoints answer, and administrative setting would allow the ETA Device 200 to also put its FXO Circuit 10 into an off-hook state. This would electrically allow a simultaneous conversation with the caller on the FXO port. This inventive method allows the VoIP endpoint to simulate another phone extension, allowing the VoIP endpoint user to be located anywhere in the world.

Another inventive method of the ETA Device 200 is the ability for the device to automatically play out a pre-recorded voice greeting at the moment the end user picks up their analog phone. This capability is valued by someone answering a high volume of incoming calls, and they want to save themselves from repeatedly making the same greeting. When an incoming call, via ether FXO port, or VoIP arrives, the analog phone on the FXS is rung. Once the user picks up the analog phone, and the ETA Device 200 detects this off-hook state, it would automatically play out the pre-recorded announcement to the source of the call. The enabling of this feature, and inputting the prerecorded greeting announcement into the ETA Device 200 is accomplished by an administrative means.

When a user on the analog phone attached to the FXS port of the ETA Device 200 initiates an outgoing call, he needs a method to indicate if the destination of the call is to be to the PSTN or to the VoIP network. With respect to the VoIP network, the user may actually have multiple VoIP destinations (services) to choose from. In the prior art, previous implementations have used DTMF key entries to select between the PSTN and one or more VoIP services. A disadvantage of this method is that an end user had to remember these multitudes of key codes. The key codes could be programmed as speed dial keys on the analog phone, but that is also a tedious task for an end user.

An inventive method is disclosed, whereby the user does not have to activate any DTMF codes. In this inventive method, all the user needs to do is to take the phone off-hook. The user is presented with a default service selection. A dial tone is audibly presented to the user, as is normal with an analog phone. If the user wants to select a different call service, the user just needs to press the “flash” button on their phone. The “flash” button, or sometimes is called the “link” button, simply takes the phone on-hook for a timed duration, typically between 500 and 2000 milliseconds. If an end users analog phone does not have the “flash” button, they can simply depress and release the phone hook switch quickly. Each time the user presses the “flash” button, they are presented with a different service selection. Once the user reaches the end of available service selections, the first service selection is presented again. Once the desired service is selected, then the user can place the call by starting to dial DTMF keys.

Administrative settings in the ETA Device 200 determine the default service selection, and contain the list of available alternative services. Each service selection made could present to the user a different dial tone, or even a short, recorded announcement to help indicate the selection made. The different services that could be available are PSTN line selection, one or more VoIP services, or extended services such as paging, door phone, door open interfaces or intercom capabilities to other VoIP devices.

To provide further intuitive feedback to the user when he has initially gone off hook, or just “flash” selected another alternative service, another inventive method of ETA Device 200 is where it has the ability to deliver a Type II call waiting FSK message sequence to the analog phone via the FXS port. For end users with a Type II call waiting compatible phone, that typically has an LCD screen, this will provide the end user with both audible and textual confirmation of their service selection.

For clarification purposes, a Type I FSK message is delivered with the analog phone is on-hook, and Type II FSK message is delivered when the phone is off-hook. The mechanisms behind FSK signaling to analog phones are well known to one skilled in the art.

The end effect is that the user has method to select different call destinations that is easier to remember and more intuative than prior art.

If there are error or status messages that are received during setup of a call with a VoIP call service, these messages can be relayed to the end users analog phone via this sane Type II call waiting FSK message mechanism.

Generic Analog Telephone Inventive Operational Methods

In general use of the ETA Device 200 it is apparent that there are certain inventive methods that can be applied to common analog telephones to enhance their usability and interactions with FXS ports, such as found on the ETA Device 200. These inventive methods are generic such that the improvements would apply to other applications where the ETA Device 200 is not even used.

The first inventive method is related to the Type II call waiting FSK messages service selection method described above. A problem with this method, is that a Type II call waiting compatible phone will typically display the message on the phone LCD, but will typically treat it like any other call waiting FSK message, and log the message into its local callers log. The same applies to any status/error messages sent. Unfortunately, the users phone caller log would over time be filled with non-pertinent data.

Hence, the inventive method is for a Type II call waiting compatible phone to support a new Type II FSK MDMF parameter type, whereby the messages are only used for informative display purposes on the analog phone. The caller-id and call-waiting-id message standard typically use a message format called MDMF. This message format embeds multiple messages. But for each sub-message, there is a parameter type field. For example, in North America, some of the defined message types are 0×01 for “Data and Time”, 0×02 for “Calling Number” and 0×07 for “Calling Name”. The general format of the MDMF message is known to one skilled in the art. To summarize, it is as follows:
I msg_type I msg_length I—message header, msg_type=0×80 for MDMF
I param_type I param_length I param_data I—one or more sub-messages
I checksum I—overall message checksum

For illustrative purposes of this inventive method, we designate a new param_type value of 0×80 for informational display purposes. A preferred embodiment format for the param_data message would be as follows:
I display_format I display_time I display_message I

where I display_format I is a byte value with the following bit meanings:
d7-d3: reserved for future use
d2-d0: =line number on the LCD display (0=1^{st} line, 3=4^{th} line)
where I display_time I is a byte value with the following bit meanings
d7-d4: On time (in seconds) to display the message
d3-d0: Off time (in seconds) to suppress displaying the message. If =0, then message is always on.

where I display_message I represents the message to be displayed on the LCD screen of the phone.

This simple message would persist on the display until the user took some other action on the analog phone, such as pressing DTMF keys, or pressing other feature keys or receiving another Type II message. Conversely, if another Type II message was sent with the on and off times were both set to zero, the message for that line would be removed.

Another inventive method is related to the Type I caller FSK message that, upon reception, would allow the user's analog phone to be set in an off hook mode, typically with a speakerphone set active. This would more gracefully support “click to dial” applications with the ETA System 100. With existing art, if a computer application activates a “click to dial” feature, it will instruct the PBX to ring up the users analog phone. Once the user has picked up the phone, the PBX will connect the call, and automatically dial the desired phone number for the user. The main disadvantage of this method is that the user's analog phone must be rung. For a busy user, this can be jarring on the nerves. This is especially true if the analog phone is a multi-handset cordless phone system, or if there are a multitude of analog phones sharing the same phone line.

With this inventive method, the ETA Device 200 would send a special Type I MDMF FSK message via the FXS port to the analog phone. This special message would be interpreted by the analog phone to take the phone off-hook, and set it to a speakerphone mode. The message format can be flexible to specify other alternative audio paths such as handset, and headset.

For illustrative purposes of this inventive method, we designate a new param_type value of 0×81 for forcing the set to an off hook mode. A preferred embodiment format for the param_data message would be as follows:
I hook_format I phone_name I

where I hook_format I is a byte value with the following bit meanings:
d7-d4 reserved for future use
d3-d0: Off hook mode.
0=force on-hook.
1=determine best audio path for situation
2=force selection of handset audio path
3=force selection of speaker phone audio path
4=force selection of headset audio path
5-15=future off hook mode options

where I phone_name I is a string name that identifies the name of the phone this message is intended for.

If a phone is left in an on-hook state, this same message can be sent as a Type II FSK off-hook message to force the phone into an on-hook state. This is to allow a device, such as the ETA Device 200, to force an on-hook state if it is deemed appropriate.

This phone_name field is to support multiple analog phones that may be connected in parallel to the same FXS port. Without this field, multiple phones would go off hook upon reception of the special FSK Type I message. To support this method, a phone name (or number identifier) entry has to be entered via administrative method on the analog phone. If this phone name matches the phone_name field, then the message is intended for that phone.

Note that this method can also be used for a multi-handset cordless phone system that resides on the FXS port. It is only one device, but it could support multiple handsets. Each cordless handset would have a handset name, which could be entered at the handset using normal keypad administrative methods. The multi-handset base station would receive the special Type I FSK message, and if the handset name matches the phone_name field, this would signal which individual handset to connect up with the call.

Another inventive method to a traditional analog phone (or cordless phone system) is a mechanism to allow an external device, such as the ETA Device 200, to detect when the analog phone is in a hold state. When a user activates the hold key on an analog phone that has that feature button, it will just typically mute the audio path in both directions. But if a device, such as the ETA Device 200, wants to play a “music-on-hold” audio signal to the caller on hold, it has no reliable mechanism to detect this. This inventive method is disclosed whereby the analog phone would transmit a pleasing audio signal before muting the audio path. The audio signal should be pleasing because the far end caller would hear it, before the device, such as a ETA Device 200, could detect the muting audio signal. The muting audio signal would be a pure single or dual tone signal and of sufficient duration (>25 ms) so that it could be reliably be detected by audio detection algorithms. To allow detection of the removed of a hold state on the analog phone, the analog phone would send out the same muting audio signal to indicate the end of the hold period. Alternatively, if another analog phone were picked up on a parallel extension, the device, such as an ETA Device 200, would detect the rapid change of line loop voltage and/or current. This event would also signal the end of the hold state.

Further extensions to these FSK Type I and Type II messages would allow an external device to remotely program a multitude of settings within a traditional analog phone. This could include programming speed dial keys, feature keys, directories, various option settings, clearing out caller log entries, and any other setting on an analog phone (or equivalent multi-handset cordless phone system). This inventive method would greatly reduce the administrative costs of deploying and configuring a multitude of analog phones.

Additional Embodiments

An additional embodiment of ETA Device 200 as represented in FIG. 2, is that each ETA Device 200 could have various combinations of FXO and FXS ports. Alternative embodiments could have just one type of port, FXS or FXO. Alternative embodiments could also have a multitude of any combination of FXO and FXS ports.

An additional embodiment of ETA Device 200 is one that uses different, or multiple, physical LAN interfaces such as wireless interfaces (802.11) or different wired interfaces such as emerging higher speed LAN interfaces or optical LAN interfaces.

An additional embodiment of ETA Device 200 is one that uses alternative LAN protocols. To one skilled in the art, many imaginative alternative or new LAN protocols could be used to implement the inventive spirit of ETA Device 200.

Conclusion, Ramifications and Scope

In the basic embodiment of the inventive Enhanced Telephony Adapter (ETA) 200 device, capabilities are brought to an analog telephone that for end-users was difficult to obtain from a single device, without resorting to using a PC.

To those skilled in the art to whom this description is addressed, it will be apparent that the embodiments previously described may be varied to meet particular specialized requirements without departing from the true spirit and scope of the invention disclosed. The previously described embodiments are thus not to be taken as indicative of the limits of the invention, but rather as exemplary structures thereof. Thus the scope of the invention should be determined by the filed claims and their legal equivalents, rather than by the examples given.

1. A enhanced Telephony Adapter apparatus comprising
a) at least one FXS Circuit operatively connected to the Computing Processor and A-D Converters;
b) the Computing Processor operatively connected to an electrical power source, and an A-D Converter, the Computing Processor for providing and receiving control and state signals to and from the FXS Circuit;
c) an A-D converter operatively connected to the Computing Processor for dealing with digitized audio signal I/O with said Computing Processor; and
d) said Computing Processor being equipped with a Memory Subsystem and a Computer Network interface capable of communication with a LAN or WAN if connected, and a user interface comprising a display and indicators.

2. The apparatus of claim 1 with the addition of:
a) an additional A-D converter operatively connected to the Computing Processor;
b) an FXO Circuit attachable to an external PSTN line and operatively connected to the Computing Processor and to the A-D converters.

3. The apparatus of claim 1, where the Computing Processor runs operating instructions programmed into the Memory Subsystem to control the operation of the apparatus, said Computing Processor and operating instructions including at least the following:
audio frequency tone generation and detection capabilities;
algorithms to perform appropriate line and acoustic echo cancellation; and
software and algorithms containing programmable functions to perform IP and VoIP protocol stacks such as TCP, UDP, RTP, and SIP as well as programmable control of signal direction, processing, and communication between the various connected I/O devices, memory, LAN, WAN, telephone network and analog phone.

4. The apparatus of claim 1 with software that operatively programs said apparatus to transmit, using type II CWID mechanisms, proxy identification to a phone that is off-hook and operatively connected to said apparatus's FXS port.

5. The apparatus of claim 4 where the next proxy identification is transmitted to the operatively connected phone each time said phone's hook is flashed.

6. The apparatus of claim 5 where the proxy profile that will be used by the apparatus to place the phone call indicated by digits the user of the phone enters is the proxy profile who's identification information is transmitted to said phone immediately prior to the user beginning to enter digits.

7. The apparatus of claim 1 operatively programmed to transmit out said apparatus's FXS port, using type II CWID mechanism, information about one of: the VOIP service being used; the VOIP call being attempted; the status of the apparatus itself.

8. The apparatus of claim 7 where instead of using type II CWID mechanism, said information is transmitted as an audible message.

9. The apparatus of claim 2 where the Computing Processor runs operating instructions programmed into the Memory Subsystem to control the operation of the apparatus, said Computing Processor and operating instructions cause the apparatus to behave as follows: when the FXO line rings the apparatus will cause the FXS port to ring and a SIP INVITE message will be sent to one or more VOIP devices operatively accessible via the Computer Network interface.

10. The apparatus of claim 9 where when the FXS port is answered before a SIP phone answers then the SIP calls are cancelled and the call from the FXO port is operatively connected to the phone attached to the FXS port.

11. The apparatus of claim 9 where when the FXS port is answered before a SIP phone answers then the SIP call calls are not cancelled for a configured period of time and if the SIP calls are answered during that time then they are conferenced to the call already in progress between the calling party on the FXO port and FXS port.

12. The apparatus of claim 9 where when a SIP phone answers before the FXS port then the apparatus stops ringing the FXS port and the call from the FXO port is operatively connected to the VOIP call.
